(19) United States
(12) Patent Application Publication
(10) Pub. No.: US 2017/0154116 A1
(43) Pub. Date: Jun. 1, 2017

(54) METHOD AND SYSTEM FOR RECOMMENDING CONTENTS BASED ON SOCIAL NETWORK

(71) Applicant: BEIJING QIHOO TECHNOLOGY COMPANY LIMITED, Xicheng District, Beijing, P.R.C. (CN)

(72) Inventors: Nan ZHOU, Chaoyang District, Beijing (CN); Fuyang CHANG, Chaoyang Distric, Beijing (CN); Jisheng QIN, Chaoyang District, Beijing (CN)

(73) Assignee: BEIJING QIHOO TECHNOLOGY COMPANY LIMITED, Xicheng District, Beijing, P.R.C. (CN)

(21) Appl. No.: 15/323,306

(22) PCT Filed: Jun. 25, 2015
(86) PCT No.: PCT/CN2015/082282

§ 371 Date: Dec. 30, 2016

(30) Foreign Application Priority Data
Jun. 30, 2014 (CN) 201410307116.X
Jun. 30, 2014 (CN) 201410308039.X

(51) Int. Cl. G06F 17/30; G06Q 50/00

(52) U.S. Cl. CPC G06F 17/30867; G06Q 50/01; G06F 17/3089

(57) ABSTRACT

The application relates to a method and system for recommending contents based on a social network, and a method and system for recommending news. The method for recommending contents based on a social network includes: extracting features of social network data; calculating and recording interest weights of the features of the social network data for a type of user according to a behavior of the type of the user on the social network data; extracting features of a plurality of contents to be pushed; finding interest weights of the features of the plurality of contents to be pushed from the recorded features and the interest weights, and calculating interest scores of the plurality of contents to be pushed for the type of the user; and pushing contents to the type of the user according to the interest scores of the plurality of contents to be pushed for the type of the user. According to the application, interests of users of different types can be analyzed, and the contents matching an interest of a user are pushed to the user.

### CROSS-REFERENCE TO RELATED APPLICATIONS

This application is the national stage of International Application No. PCT/CN2015/082282 filed Jun. 25, 2015, which claims the benefit of Chinese Patent Application No. CN201410307116.X, filed on Jun. 30, 2014 and Chinese Patent Application No. CN201410308039.X, filed on Jun. 30, 2014, and the entire contents of all of which are incorporated herein by reference.

### FIELD OF THE DISCLOSURE

The disclosure relates to the field of information technology, and particularly to a method and system for recommending contents based on a social network, and a method and system for recommending news based on a social network.

### BACKGROUND

People in the modern society have a living habit of acquiring news and information. With the development of computer technology and the continuous expansion of Internet users, more and more people use the Internet to obtain various required information. Meanwhile, more and more websites provide news and information services through the Internet. More and more emergent news and events are spread rapidly through the Internet, and Internet information has an explosive growth trend. In recent years, the rapid development of mobile Internet makes the user's reading time increasingly become fragments. In this context, it becomes extremely important that how to filter out the most valuable information in the vast amount of information, to recommend personalized news and information on user's interest to the user.

The existing Internet news reading products mainly include web (web page) terminals and mobile app (application) terminals. From the integration approach of news and information, the majority are still in the form of manual editing and category browsing. The reading in this way may allow users to browse a large amount of news and information that the users are not interested in and waste users' time. Meanwhile, while a lot of editing is required for the product itself to update and maintain news and information. A subscription news reader product such as google reader (Reading thorough Google) differs from the product described above in that the users can subscribe the content of the website which they are interested in, for reading and browsing. With this way of reading, likelihood is reduced that the user brows the content that the user is not interested in, but the users have to seek for contents and websites on their interest and perform a series of settings, most of Internet users do not like this cumbersome way.

In order to obtain by the user the most valuable and interested news and information in the most convenient way during the shortest time, it is necessary to adopt a more intelligent way to provide the information required for the users, and to recommend most valuable and interested news and information to different users.

### SUMMARY OF THE DISCLOSURE

In view of aforesaid problems, the disclosure provides a method and system for recommending contents based on a social network, and a method and system for recommending news based on a social network, to overcome the aforesaid problems or at least partially solve the aforesaid problems.

In a first aspect of the disclosure, there is provided a method for recommending contents based on a social network, which includes: extracting features of social network data; calculating and recording interest weights of the features of the social network data for a type of user according to a behavior of the type of the user on the social network data; extracting features of multiple contents to be pushed; finding interest weights of the features of the multiple contents to be pushed from the recorded features and the interest weights, and calculating interest scores of the multiple contents to be pushed for the type of the user; and pushing contents to the type of the user according to the interest scores of the multiple contents to be pushed for the type of the user.

In a second aspect of the disclosure, there is further provided a system for recommending contents based on a social network, which includes: a first feature extracting module, adapted to extract features of social network data; an interest weight calculating module, adapted to calculate and record interest weights of the features of the social network data for a type of user according to a behavior of the type of the user on the social network data; a second feature extracting module, adapted to extract features of multiple contents to be pushed; an interest score calculating module, adapted to find interest weights of the features of the multiple contents to be pushed from the recorded features and the interest weights, and calculate interest scores of the multiple contents to be pushed for the type of the user; and a content recommending module, adapted to pushed contents to the type of the user according to the interest scores of the multiple contents to be pushed for the type of the user.

In the method and system for recommending contents based on a social network in the disclosure, since social behaviors of users of different types on the network can reflect the interests of users of the types, the behaviors of the users of different types to the social network data are analyzed to obtain the interest weights of the features of the social network data for the users of different types and calculate interest scores of the contents to be pushed for the users of different types. In this way, in practice, levels of interests of the users of different types to the contents to be pushed are distinguished reasonably, and recommendations are made for the users of different types according to the levels of interests. In the technical solution of the disclosure, the recommended contents are shown to the user, which greatly reduces the workload of the manual editing; for the user, the readability of the recommended contents is improved, a large amount of recommended contents which the users do not like are reduced, the user's time is saved, more users are attracted with the increased recommendation quality, which increases the click-through rate of recommended content, and ultimately leads to a steady increase in push flow.

In a third aspect of the disclosure, there is provided a computer readable medium, which stores computer readable codes, wherein the computer readable codes, when being run on a computing device, cause the computing device to: extract features of social network data; calculate and record interest weights of the features of the social network data for a type of user according to a behavior of the type of the user on the social network data; extract features of a plurality of contents to be pushed; find interest weights of the features of the plurality of contents to be pushed from the recorded features and the interest weights, and calculate interest scores of the plurality of contents to be pushed for the type of the user; and push contents to the type of the user according to the interest scores of the plurality of contents to be pushed for the type of the user.

Above description is only a summary of the technical scheme of the disclosure. In order to know the technical means of the disclosure more clearly so that it can be put into effect according to the content of the description, and to make aforesaid and other purpose, features and advantages of the disclosure clearer, the embodiments of the disclosure are listed below.

### BRIEF DESCRIPTION OF THE DRAWINGS

By reading the detailed description of the preferably selected embodiments below, various other advantages and benefits become clear for a person of ordinary skill in the art. The drawings are only used for showing the purpose of the preferred embodiments and are not intended to limit the present invention. And in the whole drawings, same drawing reference signs are used for representing same components. In the drawings:

FIG. 1 shows a flow chart of a method for recommending contents based on a social network in accordance with an embodiment of the disclosure;

FIG. 2 shows a flow chart of a method for recommending contents based on a social network in accordance with an embodiment of the disclosure;

FIG. 3 shows a working flow chart of a method for recommending contents based on a social network in accordance with an embodiment of the disclosure;

FIG. 4 shows a block diagram of a system for recommending contents based on a social network in accordance with an embodiment of the disclosure;

FIG. 5 shows a block diagram of a system for recommending contents based on a social network in accordance with an embodiment of the disclosure;

FIG. 6 shows a flow chart of a system for recommending news in accordance with an embodiment of the disclosure;

FIG. 7 shows a flow chart of a method for recommending news in accordance with an embodiment of the disclosure;

FIG. 8 shows a working flow chart of a method for recommending news in accordance with an embodiment of the disclosure;

FIG. 9 shows a block diagram of a system for recommending news in accordance with an embodiment of the disclosure;

FIG. 10 shows a block diagram of a system for recommending news in accordance with an embodiment of the disclosure;

FIG. 11 schematically shows a block diagram for a computing device for executing the method for recommending contents based on a social network and/or the method for recommending news based on a social network according to the disclosure; and

FIG. 12 schematically shows a storage cell for holding or carrying procedure codes for realizing the method for recommending contents based on a social network and/or the method for recommending news based on a social network according to the disclosure.

### DETAILED DESCRIPTION

The disclosure is described in further detail with reference to the drawings and embodiments below.

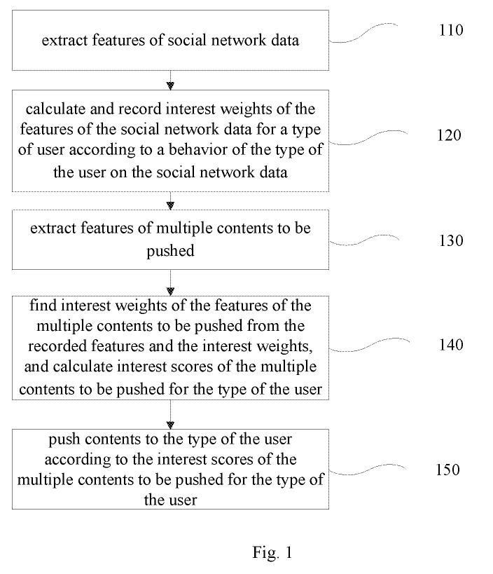

As shown in FIG. 1, a method for recommending contents based on a social network is provided according to an embodiment of the disclosure, which includes the following steps 110 to 150.

In step 110, features of social network data are extracted. In this embodiment, the type of the social network data is not limited, for example, which may be a social web site or a social tool which is used by the user, such as a microblog, a blog, or, for example, which may be a name, a category and a label content of the social web site or the social tool.

In step 120, interest weights of the features of the social network data for a type of user are calculated and recorded according to a behavior of the type of the user on the social network data. For example, a user frequently sends sport messages on the social network, thus it shows that the user have a stronger interest in sport contents.

In step 130, features of multiple contents to be pushed are extracted. In this embodiment, the contents to be pushed include, but are not limited to, news and information, or other forms of information.

In step 140, interest weights of the features of the multiple contents to be pushed are found from the recorded features and the interest weights, and interest scores of the multiple contents to be pushed for the type of the user are calculated. In the technical solution of the embodiment, a user's interest model can be established according to the features of the social network data and the corresponding interest weights described above, and the candidate contents needed to be pushed to the user can be selected based on the interest model.

In step 150, contents are pushed to the type of the user according to the interest scores of the multiple contents to be pushed for the type of the user. In this embodiment, the contents to be pushed are sorted based on the interest scores, and the set of contents and the sort of the contents to be finally recommended to the user can be determined based on the sorting result.

In the technical solution of the embodiment, contents are pushed according to the interest scores, that is, interests of users of different types in the contents to be pushed, which greatly reduces the workload of the manual editing; for the user, the readability of the recommended contents is improved, a large amount of recommended contents which the users do not like are reduced, the user's time is saved, more users are attracted with the increased recommendation quality, which increases the click-through rate of recommended content, and ultimately leads to a steady increase in the push flow.

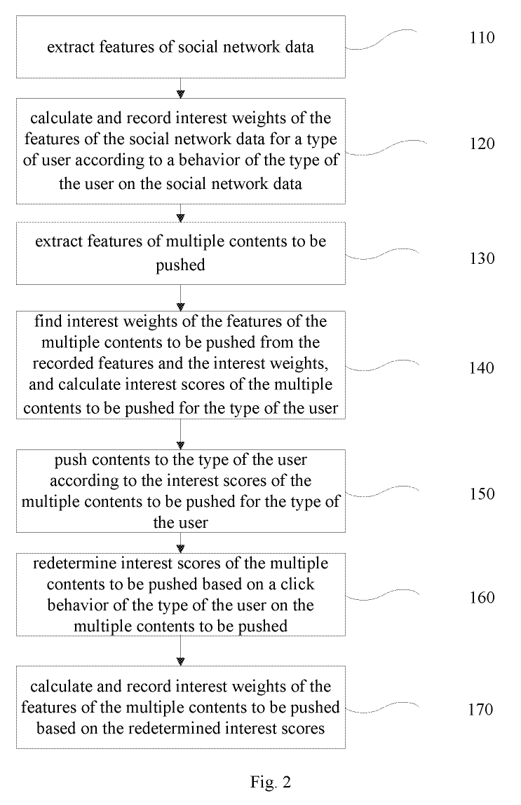

As shown in FIG. 2, a method for recommending contents based on a social network is further provided according to another embodiment of the disclosure, which further includes the following steps 160 and 170.

In step 160, interest scores of the multiple contents to be pushed are redetermined based on a click behavior of the type of the user on the multiple contents to be pushed.

In step 170, interest weights of the features of the multiple contents to be pushed are calculated and recorded based on the redetermined interest scores.

In the technical solution of the embodiment, if the user clicks and reads the pushed contents, it indicates that the push is accurate; but if the user clicks a button of disinterest for the pushed content, it indicates the user has less interest of the features such as category or theme corresponding to the content. In this case, the interest score of the content is estimated based on the actual behavior of the user and the interest weights of the features of the content are modified in reverse, so that the calculated interest score is more consistent with the actual interest of the user later.

A method for recommending contents based on a social network is further provided according to another embodiment of the disclosure. The social network data includes a social network account, the features of the social network data include a category and a theme of the social network account, and the behaviors of the type of the user on the social network data includes concern behaviors on the social network accounts of the same category or the same theme.

In the technical solution of the embodiment, taking the current popular microblog as an example, if the user concerns a media account or a famous person's account, it indicates that the user has an interest in the type or theme of microblog account. More microblog accounts of the same label the user concerns, and then a higher interest weight can be set. A category, theme or other forms of labels can be set correspondingly for a microblog account currently. At least one label can be pre-defined for different microblog accounts, and the features of the microblog account can be recorded in the labels. The labels of the microblog account can be stored in a database, to be extracted as needed.

A method for recommending contents based on a social network is further provided according to another embodiment of the disclosure. The social network data includes social contents posted in a social network account. The features of the social network data include a category and a theme of the social contents, and the behaviors of the type of the user on the social network data includes forwarding behaviors on the social contents of the same category or the same theme.

In the technical solution of the embodiment, taking a text posted on the current popular microblog as an example, if the user forwards the text of the microblog account of a category or theme more times, it indicates that the user has a stronger interest in the text of the microblog account of the category or theme, and then a higher interest weight can be set.

A method for recommending contents based on a social network is further provided according to another embodiment of the disclosure. The social network data includes a URL posted in a social network account, the features of the social network data include a category and a theme of the pushed content pointed by the URL, and the behavior of the type of the user on the social network data includes click behaviors on the URLs for the pushed contents of the same category or the same theme, or click behaviors on page labels for the pushed contents of the same category or the same theme.

In the technical solution of the embodiment, category labels can be set for different pushed contents in advance. For example, if the pushed content is sport information, its label is set to be a sport label. Category labels for domain names can be pre-stored in the database. In the embodiment of the embodiment, if the user clicks news pointed by the URL posted in a social account, it indicates that the user is interested in the category and theme of the domain name, and then a higher interest weight can be set.

A method for recommending contents based on a social network is further provided according to another embodiment of the disclosure. The social network data includes a URL posted in a social network account, the features of the social network data include a category of a domain name included on the URL, and the behavior of the type of the user on the social network data includes click behaviors on the URLs corresponding to the domain names of the same category.

In the technical solution of the embodiment, category labels can be set for different domain names in advance. For example, a category label for a domain name usually refers to an information category of the web page contained in the webpage under the domain name, such as sports.abc.com, under which a webpage may contain various aspects of sport information, and then the category label for this domain name can be identified as “sport”. Category labels for domain names can be pre-stored in the database.

In the technical solution of the embodiment, if the user clicks the news pointed by the URL posted in a social account, it indicates that the user is interested in the category and theme of the domain name, and then a higher interest weight can be set.

A method for recommending contents based on a social network is further provided according to another embodiment of the disclosure. An interest score of the i-th content to be pushed is as follows:

$$P = \frac{a}{b + {e}^{- g ( {V}_{i} )}}$$

wherein Vᵢ=x₁×x₁+x₂×w₂+ . . . +x_{N}×w_{N}, w₁ . . . w_{N} are N features of the i-th content to be pushed, x₁ . . . x_{N} are interest weights corresponding to N features, a is a first constant, b is a second constant, and e and g are fixed constants.

In the technical solution of the embodiment, a sorting model may be achieved according to the above-mentioned score formula. The model is used to calculate interest scores with the above formula. The sorting model is actually a logic regression classifier. A feature of the pushed content is an input of the logic regression classifier, and the output of the logic regression classifier is the interest score of the pushed content for a type of user. The higher the score is, the stronger the user is interested in the content to be pushed. Each piece of pushed content can be abstracted as a feature vector, and dimensions of the vector represent a plurality of features of the content to be pushed, such as a theme, category, even keywords, hot degree.

Assuming that a model coefficient vector X={x₁,x₂, . . . , x_{N}} has been obtained based on the above-mentioned interest weights, a logic regression classifier for calculating interest values of the rushed contents may be expressed as:

$$P ( Y = 1 \vert {news}_{i} ) = \frac{1}{1 + {e}^{- g ( V )}}$$

wherein V=XW, X represents a model coefficient vector corresponding to the user of the above-mentioned type, and W represents a feature vector of the pushed content. The meaning at the left side of the above equation is the probability of user clicking when a pushed content newsᵢ is recommended to the user, and thus the calculated interest scores at the right side can be used as a basis for pushing contents to the type of the user.

In conjunction with the foregoing embodiment, when the user processes the pushed content, W is known, X is unknown, and then X needs to be determined.

According to the click behavior feedback of the user, a set of the pushed content clicked by the user and a set of contents which have been pushed to the user but not clicked by the user can be obtained. For the pushed content news_{c} clicked by the user, the following can be obtained

$$P ( Y = 1 \vert {news}_{c} ) = \frac{1}{1 + {e}^{- g ( {V}_{c} )}} = 1$$

For the pushed content news_{d} which is not clicked by the user, the following can be obtained.

$$P ( Y = 1 \vert {news}_{d} ) = \frac{1}{1 + {e}^{- g ( {V}_{d} )}} = 0$$

Thus, m formulas with forms as the two expressions described above can be obtained according to records of a user clicking m pieces of the pushed contents, the m formulas are solved simultaneously to obtain the sorting model coefficient vector X of the user, that is, interest weights are modified.

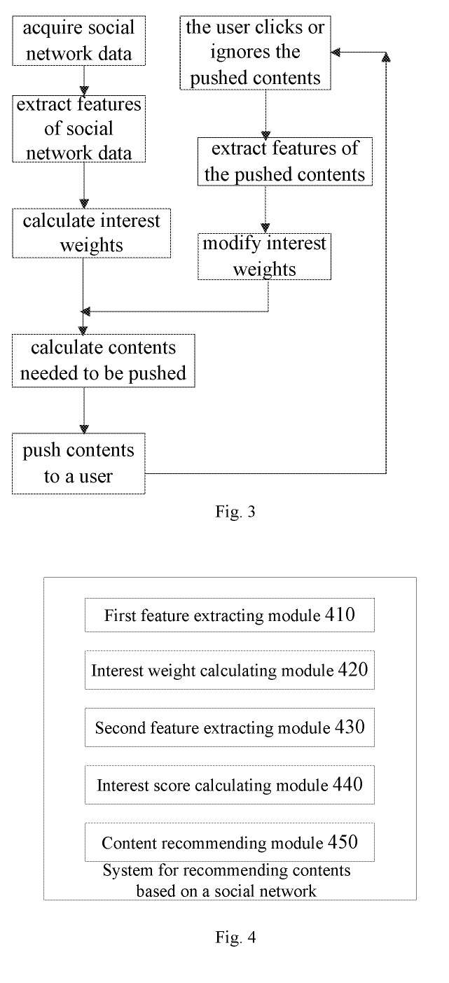

After the interest weights are modified, assuming that the model coefficient vector is {x₁, x₂, . . . , x_{N}}, each piece of pushed content in the set of candidate pushed contents is extracted to obtain a corresponding feature vector Wᵢ={w₁, w₂, . . . , w_{N}}, which is brought into the following model.

$$P ( Y = 1 \vert {news}_{i} ) = \frac{1}{1 + {e}^{- g ( {V}_{i} )}} ,$$

wherein Vᵢ=x₁×w₁+x₂×x₂+ . . . +x_{N}×w_{N}, and P(Y=1|newsᵢ) is obtained through calculation. This value is an interest score for this item to the user. The order of recommending contents to the user can be determined based on the interest scores of the candidate pushed contents. Thus, in the technical solution of the embodiment, the interest weights are modified according to the actual click behavior of the user on the pushed contents, which benefits to push contents again to the user more accurately. Finally, a technical solution is obtained according to this embodiment in conjunction with the above-described embodiments, of which the working flow is shown in FIG. 3.

It should be noted that the above-mentioned formulas are not unique formulas for realizing the present disclosure, but are merely an implementation way of the embodiment. Those skilled in the art may suitably deform the formulas according to business needs, which still falls within the scope of the present disclosure, such as adding parameters or fold values.

As shown in FIG. 4, a system for recommending contents based on a social network is further provided according to another embodiment of the disclosure, which includes a first feature extracting module 410, an interest weight calculating module 420, a second feature extracting module 430, an interest score calculating module 440 and a content recommending module 450.

The first feature extracting module 410 is adapted to extract features of social network data. In this embodiment, the type of the social network data is not limited, for example, which may be a social web site or a social tool which is used by the user, such as a microblog, a blog, or, for example, which may be a name, a category and a label content of the social web site or the social tool.

The interest weight calculating module 420 is adapted to calculate and record interest weights of the features of the social network data for a type of user according to a behavior of the type of the user on the social network data. For example, a user frequently sends sport messages on the social network, thus it shows that the user have a stronger interest in sport contents.

The second feature extracting module 430 is adapted to extract features of multiple contents to be pushed. In this embodiment, the contents to be pushed include, but are not limited to, news and information, or other forms of information.

The interest score calculating module 440 is adapted to find interest weights of the features of the multiple contents to be pushed from the recorded features and the interest weights, and calculate interest scores of the multiple contents to be pushed for the type of the user. In the technical solution of the embodiment, a user's interest model can be established according to the features of the social network data and the corresponding interest weights described above, and the candidate contents needed to be pushed to the user can be selected based on the interest model.

The content recommending module 450 is adapted to pushed contents to the type of the user according to the interest scores of the multiple contents to be pushed for the type of the user. In this embodiment, the contents to be pushed are sorted based on the interest scores, and the set of contents and the sort of the contents to be finally recommended to the user can be determined based on the sorting result.

In the technical solution of the embodiment, contents are recommended according to the interest scores, that is, interests of users of different types in the contents to be pushed, which greatly reduces the workload of the manual editing; for the user, the readability of the recommended contents is improved, a large amount of recommended contents which the users do not like are reduced, the user's time is saved, more users are attracted with the increased recommendation quality, which increases the click-through rate of recommended content, and ultimately leads to a steady increase in the push flow.

As shown in FIG. 5, a system for recommending contents based on a social network is further provided according to another embodiment of the disclosure, which further includes:

a first redetermining module 460, adapted to redetermine interest scores of the multiple contents to be pushed based on a click behavior of the type of the user on the multiple contents to be pushed; and

a second redetermining module 470, adapted to calculate and record interest weights of the features of the multiple contents to be pushed based on the redetermined interest scores.

In the technical solution of the embodiment, if the user clicks and reads the pushed content, it indicates that the push is accurate; but if the user clicks a button of disinterest for the pushed content, it indicates the user has less interest of the features such as category or theme corresponding to the content. In this case, the interest score of the content is estimated based on the actual behavior of the user and the interest weights of the features of the content are modified in reverse, so that the calculated interest score is more consistent with the actual interest of the user.

A system for recommending contents based on a social network is further provided according to another embodiment of the disclosure. The social network data includes a social network account, the features of the social network data include a category and a theme of the social network account, and the behavior of the type of the user on the social network data includes a concern behavior on the social network accounts of the same category or the same theme.

In the technical solution of the embodiment, taking the current popular microblog as an example, if the user concerns a media account or a famous person's account, it indicates that the user has an interest in the type or theme of microblog account. More microblog accounts of the same label the user concerns, and then a higher interest weight can be set. A category, theme or other forms of labels can be set correspondingly for a microblog account currently. At least one label can be pre-defined for different microblog accounts, and the features of the microblog account can be recorded in the labels. The labels of the microblog account can be stored in a database, to be extracted as needed.

A system for recommending contents based on a social network is further provided according to another embodiment of the disclosure. The social network data includes social contents posted in a social network account. The features of the social network data include a category and a theme of the social contents, and the behavior of the type of the user on the social network data includes a forwarding behavior on the social contents of the same category or the same theme.

In the technical solution of the embodiment, taking a text posted on the current popular microblog as an example, if the user forwards the text of the microblog account of a category or theme more times, it indicates that the user has a stronger interest in the text of the microblog account of the category or theme, and then a higher interest weight can be set.

A system for recommending contents based on a social network is further provided according to another embodiment of the disclosure. The social network data includes a URL posted in a social network account, the features of the social network data include a category and a theme of the pushed content pointed by the URL, and the behavior of the type of the user on the social network data includes a click behavior on the URL for the pushed contents of the same category or the same theme, or a click behavior on a page label for the pushed contents of the same category or the same theme.

In the technical solution of the embodiment, category labels can be set for different pushed contents in advance. For example, if the pushed content is sport information, its label is set to be a sport label. Category labels for domain names can be pre-stored in the database. In the embodiment of the embodiment, if the user clicks news pointed by the URL posted in a social account, it indicates that the user is interested in the category and theme of the domain name, and then a higher interest weight can be set.

A system for recommending contents based on a social network is further provided according to another embodiment of the disclosure. The social network data includes a URL posted in a social network account, the features of the social network data include a category of a domain name included on the URL, and the behavior of the type of the user on the social network data includes a click behavior on the URL corresponding to the domain name of the same category.

In the technical solution of the embodiment, category labels can be set for different domain names in advance. For example, a category label for a domain name usually refers to an information category of the web page contained in the webpage under the domain name, such as sports.abc.com, under which a webpage may contain various aspects of sport information, and then the category label for this domain name can be identified as “sport”. Category labels for domain names can be pre-stored in the database.

In the technical solution of the embodiment, if the user clicks the news pointed by the URL posted in a social account, it indicates that the user is interested in the category and theme of the domain name, and then a higher interest weight can be set.

A system for recommending contents based on a social network is further provided according to another embodiment of the disclosure. An interest score of the i-th content to be pushed is as follows:

$$P = \frac{a}{b + {e}^{- g ( {V}_{i} )}}$$

wherein Vᵢ=x₁×w₁+x₂×w₂+ . . . +x_{N}×w_{N}, w₁ . . . w_{N} are N features of the i-th content to be pushed, x₁ . . . x_{N} are interest weights corresponding to N features, a is a first constant, b is a second constant, and e and g are fixed constants.

In the technical solution of the embodiment, a sorting model may be achieved according to the above-mentioned score formula. The model is used to calculate interest scores with the above formula. The sorting model is actually a logic regression classifier. A feature of the pushed content is an input of the logic regression classifier, and the output of the logic regression classifier is the interest score of the pushed content for a type of user. The higher the score is, the stronger the user is interested in the content to be pushed. Each piece of pushed content can be abstracted as a feature vector, and dimensions of the vector represent a plurality of features of the content to be pushed, such as a theme, category, even keywords, hot degree.

Assuming that a model coefficient vector X={x₁, x₂, . . . , x_{N}} has been obtained based on the above-mentioned interest weights, a logic regression classifier for calculating interest values of the pushed contents may be expressed as:

$$P ( Y = 1 \vert {news}_{i} ) = \frac{1}{1 + {e}^{- g ( V )}}$$

wherein V=XW, X represents a model coefficient vector corresponding to the user of the above-mentioned type, and W represents a feature vector of the pushed content. The meaning at the left side of the above equation is the probability of user clicking when a pushed content newsᵢ is recommended to the user, and thus the calculated interest scores at the right side can be used as a basis for pushing contents to the type of the user.

In conjunction with the foregoing embodiment, when the user processes the pushed content, W is known, X is unknown, and then X is determined.

According to the click behavior feedback of the user, a set of the pushed content clicked by the user and a set of contents which have been pushed to the user but are not clicked by the user can be obtained. For the pushed content news_{c} clicked by the user, the following can be obtained.

$$P ( Y = 1 \vert {news}_{c} ) = \frac{1}{1 + {e}^{- g ( {V}_{c} )}} = 1$$

For the pushed content news_{d} which is not clicked by the user, the following can be obtained.

$$P ( Y = 1 \vert {news}_{d} ) = \frac{1}{1 + {e}^{- g ( {V}_{d} )}} = 0$$

Thus, m formulas with forms as the two expressions described above can be obtained according to records of a user clicking m pieces of the pushed contents, the m formulas are solved simultaneously to obtain the sorting model coefficient vector X of the user, that is, interest weights are modified.

After the interest weights are modified, assuming that the model coefficient vector is {x₁, x₂, . . . , x_{N}}, each piece of pushed content in the set of candidate pushed contents is extracted to obtain a corresponding feature vector Wᵢ{w₁, w₂, . . . , w_{N}}, which is brought into the following model.

$$P ( Y = 1 \vert {news}_{i} ) = \frac{1}{1 + {e}^{- g ( {V}_{i} )}} ,$$

wherein Vᵢ=x₁×w₁+x₂×w₂+ . . . +x_{N}×w_{N}, and P(Y=1|newsᵢ) is obtained through calculation. This value is an interest score for this item to the user. The order of recommending contents to the user can be determined based on the interest scores of the candidate pushed contents. Thus, in the technical solution of the embodiment, the interest weights are modified according to the actual click behavior of the user on the pushed contents, which benefits to push contents again to the user more accurately. Finally, a technical solution is obtained according to this embodiment in conjunction with the above-described embodiments, of which the working flow is shown in FIG. 3.

A method and system for recommending news according to embodiments of the present disclosure are illustrated below.

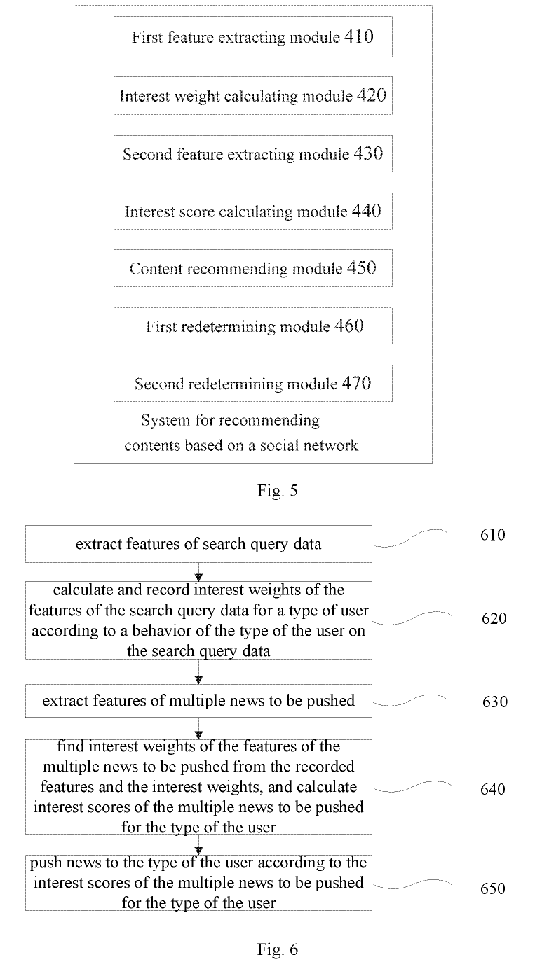

As shown in FIG. 6, a method for recommending news is provided according to an embodiment of the disclosure, which includes the following steps 610 to 650.

In step 610, features of search query data are extracted. In this embodiment, the type of the search query data is not limited and the type of the search query data may be, for example, the user's browsing status for the searched news. The features of the search query data also are not limited in this embodiment, and the features may be, for example, a category, title, keywords, news sources, website sources, geographical labels, click-through rate of news browsed by the user.

In step 620, interest weights of the features of the search query data for a type of user are calculated and recorded according to a behavior of the type of the user on the search query data. For example, with regard to the browsing behavior, the user must have a stronger interest in first browsing, repeat browsing news, thus, user's interest weights can be analyzed.

In step 630, features of multiple news to be pushed are extracted.

In step 640, interest weights of the features of multiple news to be pushed are found from the recorded features and the interest weights, and interest scores of the multiple news to be pushed for the type of the user are calculated. In the technical solution of the embodiment, a user's interest model can be established according to the features of the search query data and the corresponding interest weights described above, and the candidate news needed to be pushed to the user can be selected based on the interest model.

In step 650, news is pushed to the type of the user according to the interest scores of the multiple news to be pushed for the type of the user. In this embodiment, the news to be pushed are sorted based on the interest scores, and the set of news and the sort of the news to be finally recommended to the user can be determined based on the sorting result.

In the technical solution of the embodiment, news are pushed according to the interest scores, that is, interests of users of different types in the news to be pushed, which greatly reduces the workload of the manual editing; for the user, the readability of the news is improved, a large amount of news which the users do not like are reduced, the user's time is saved, more users are attracted with the increased recommendation quality, which increases the click-through rate of each piece of news, and ultimately leads to a steady increase in the news flow.

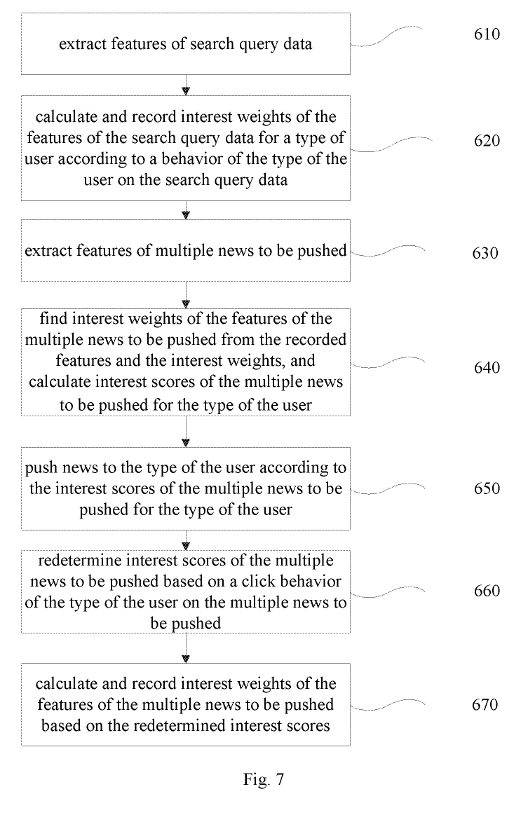

As shown in FIG. 7, a method for recommending news is further provided according to another embodiment of the disclosure, which further includes the following steps 660 and 670.

In step 660, redetermining interest scores of the multiple news to be pushed based on a click behavior of the type of the user on the multiple news to be pushed; and

In step 670, calculating and recording interest weights of the features of the multiple news to be pushed based on the redetermined interest scores.

In the technical solution of the embodiment, if the user clicks and reads the pushed new, it indicates that the push is accurate; but if the user clicks a button of disinterest for the pushed new, it indicates the user has less interest of the features such as category or theme corresponding to the news. In this case, the interest score of the new is estimated based on the actual behavior of the user and the interest weights of the features of the new are modified in reverse, so that the calculated interest score is more consistent with the actual interest of the user later.

A method for recommending news is further provided according to another embodiment of the disclosure. The search query data includes a query term, the features of the search query data include a category and a theme of the query term, and the behaviors of the type of the user on the search query data includes query behaviors on the query terms of the same category or the same theme.

In the technical solution of the embodiment, a category label and theme label of the query word can be determined in advance according to the category label and theme label of news in a new set corresponding to the query word, a database is set up for storing category labels and theme labels, and the category and theme of the query word can be extracted from the category labels and theme labels in the database. For example, query word abc is searched, if the most theme label of the obtained news is t1, the theme label corresponding to the query word is t1; if the most category label of the obtained news is c1, the category label corresponding to the query word is c1, and then t1 and c1 can be extracted as the features of the category and theme of the query word.

In the technical solution of the embodiment, the difference in the querying behavior of a user on a query word mainly includes difference in the search frequency and difference in the search time. The higher the frequency of searching for a query word, the stronger the interest of the user, then a higher interest weight can be set for the category and the theme of the query word. Meanwhile, the closer the search time points at which a user searches the query word many times are to the current time points, the stronger the interest of the user, then a higher interest weight can be set for the category and the theme of the query word.

A method for recommending news is further provided according to another embodiment of the disclosure. The search query data includes a URL on a query result page, the features of the search query data include a category and a theme of news pointed by the URL, and the behavior of the type of the user on the search query data includes click behaviors on the URLs for the news of the same category or the same theme, or click behaviors on page labels for the news of the same category or the same theme.

In the technical solution of the embodiment, a category label and at least one theme label may be set in advance for each piece of news, and the category and at least one theme of the news may be recorded therein respectively.

In the technical solution of the embodiment, if the user clicks and reads a news pointed by a URL searched, it indicates that the user is interested in the category and theme of the news, and then a higher interest weight can be set; or, if the user clicks a news classifying channel pointed by a URL, and news of the classifying channel has the same category label, it indicates that the user is interested in the category of the new, and then a higher interest weight can be set.

A method for recommending news is further provided according to another embodiment of the disclosure. The search query data includes a URL posted in a social network account, the features of the search query data include a category of a domain name included on the URL, and the behavior of the type of the user on the search query data includes click behaviors on the URLs corresponding to the domain names of the same category.

In the technical solution of the embodiment, category labels can be set for different domain names in advance. For example, a category label for a domain name usually refers to an information category of the web page contained in the webpage under the domain name, such as sports.abc.com, whose webpage may contain various aspects of sport information, and then the category label for this domain name can be identified as “sport”. Category labels for domain names can be pre-stored in the database.

In the technical solution of the embodiment, if the user finds URL posted in a social account by searching and clicks and reads the news pointed by the URL, it indicates that the user is interested in the category and theme of the domain name, and then a higher interest weight can be set.

A method for recommending news is further provided according to another embodiment of the disclosure. An interest score of the i-th new to be pushed is as follows:

$$P = \frac{a}{b + {e}^{- g ( {V}_{i} )}}$$

wherein Vᵢ=x₁×w₁+x₂×w₂+ . . . +x_{N}×w_{N}, w₁ . . . w_{N} are N features of the i-th news to be pushed, x₁ . . . x_{N} are interest weights corresponding to N features, a is a first constant, b is a second constant, and e and g are fixed constants.

In the technical solution of the embodiment, a sorting model may be achieved according to the above-mentioned score formula. The model is used to calculate interest scores with the above formula. The sorting model is actually a logic regression classifier. A feature of the news is an input of the logic regression classifier, and the output of the logic regression classifier is the interest score of the news for a type of user. The higher the score is, the stronger the user is interested in the news to be pushed. Each piece of news can be abstracted as a feature vector, and dimensions of the vector represent a theme, category, even keywords, hot degree and other features of the piece of the news.

Assuming that a model coefficient vector X={x₁, x₂, . . . , x_{N}} has been obtained based on the above-mentioned interest weights, a logic regression classifier for calculating interest values of the news may be expressed as:

$$P ( Y = 1 \vert {news}_{i} ) = \frac{1}{1 + {e}^{- g ( V )}}$$

wherein V=XW, X represents a model coefficient vector corresponding to the user of the above-mentioned type, and W represents a feature vector of the news. The meaning at the left side of the above equation is the probability of user clicking when the piece of news newsᵢ is recommended to the user, and thus the calculated interest scores at the right side can be used as a basis for pushing news to the type of the user.

In conjunction with the foregoing embodiment, when the user processes the pushed news, W is known, X is unknown, and then X needs to be determined.

According to the click behavior feedback of the user, a set of the news clicked by the user and a set of news which have been pushed to the user but are not clicked by the user can be obtained. For the pushed news news_{c} clicked by the user, the following can be obtained.

$$P ( Y = 1 \vert {news}_{c} ) = \frac{1}{1 + {e}^{- g ( {V}_{c} )}} = 1$$

For the pushed news news_{d} which is not clicked by the user, the following can be obtained.

$$P ( Y = 1 \vert {news}_{d} ) = \frac{1}{1 + {e}^{- g ( {V}_{d} )}} = 0$$

Thus, m formulas with forms as the two expressions described above can be obtained according to records of a user clicking m pieces of the pushed news, the m formulas are solved simultaneously to obtain the sorting model coefficient vector X of the user, that is, interest weights are modified.

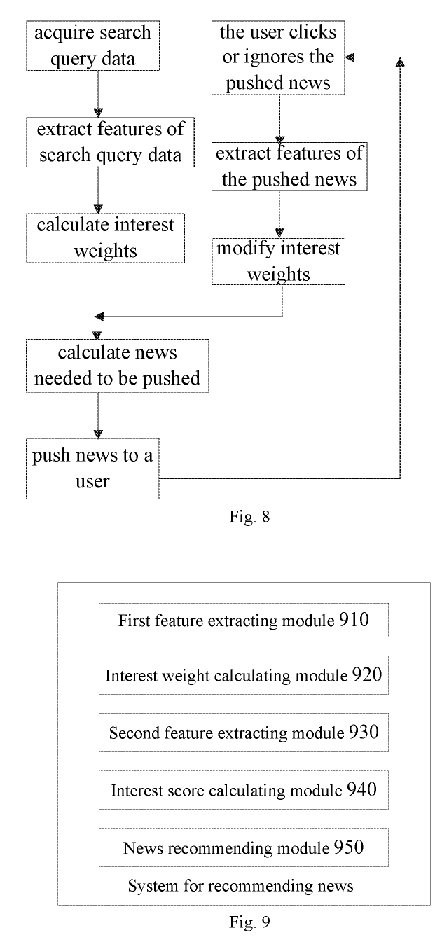

After the interest weights are modified, assuming that the model coefficient vector is {x₁, x₂, . . . , x_{N}}, each piece of news in the set of candidate news is extracted to obtain a corresponding feature vector Wᵢ={w₁, w₂, . . . , w_{N}}, which is brought into the following model.

$$P ( Y = 1 \vert {news}_{i} ) = \frac{1}{1 + {e}^{- g ( {V}_{i} )}} ,$$

wherein Vᵢ=x₁×w₁+x₂×w₂+ . . . +x_{N}×w_{N}, and P(Y=1|newsᵢ) is obtained through calculation. This value is an interest score for the piece of news to the user. The order of recommending news to the user can be determined based on the interest scores of the candidate news. Thus, in the technical solution of the embodiment, the interest weights are modified according to the actual click behavior of the user on the pushed news, which benefits to push news again to the user more accurately. Finally, a technical solution is obtained according to this embodiment in conjunction with the above-described embodiments, of which the working flow is shown in FIG. 8.

It should be noted that the above-mentioned formulas are not unique formulas for realizing the present disclosure, but are merely an implementation way of the embodiment. Those skilled in the art may suitably deform the formulas according to business needs, which still falls within the scope of the present disclosure, such as adding parameters or fold values.

As shown in FIG. 9, a system for recommending news is further provided according to another embodiment of the disclosure, which includes a first feature extracting module 910, an interest weight calculating module 920, a second feature extracting module 930, an interest score calculating module 940, and a news recommending module 950.

The first feature extracting module 910 is adapted to extract features of search query data. In this embodiment, the type of the search query data is not limited, and the type of the search query data may be, for example, the user's browsing status for the searched news. The features of the search query data also are not limited in this embodiment, and the features may be, for example, a category, title, keywords, news sources, website sources, geographical labels, click-through rate of news browsed by the user.

The interest weight calculating module 920 is adapted to calculate and record interest weights of the features of the search query data for a type of user according to a behavior of the type of the user on the search query data. For example, with regard to the browsing behavior, the user must have a stronger interest in first browsing, repeat browsing news, thus, user's interest weights can be analyzed.

The second feature extracting module 930 is adapted to extract features of multiple news to be pushed.

The interest score calculating module 940 is adapted to find interest weights of the features of the multiple news to be pushed from the recorded features and the interest weights, and calculate interest scores of the multiple news to be pushed for the type of the user. In the technical solution of the embodiment, a user's interest model can be established according to the features of the search query data and the corresponding interest weights described above, and the candidate news needed to be pushed to the user can be selected based on the interest model.

The news recommending module 950 is adapted to push news to the type of the user according to the interest scores of the multiple news to be pushed for the type of the user. In this embodiment, the news to be pushed is sorted based on the interest scores, and the set of news and the sort of the news to be finally recommended to the user can be determined based on the sorting result.

In the technical solution of the embodiment, news are pushed according to the interest scores, that is, interests of users of different types in the news to be pushed, which greatly reduces the workload of the manual editing; for the user, the readability of the news is improved, a large amount of news which the users do not like are reduced, the user's time is saved, more users are attracted with the increased recommendation quality, which increases the click-through rate of each piece of news, and ultimately leads to a steady increase in the news flow.

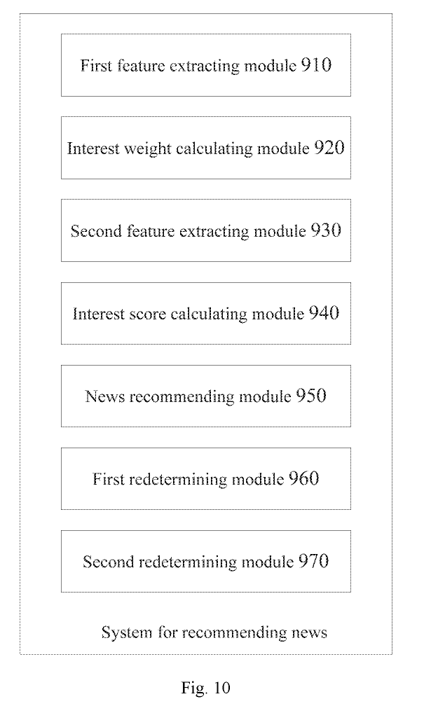

As shown in FIG. 10, a system for recommending news is further provided according to another embodiment of the disclosure, which further includes:

a first redetermining module 960, adapted to redetermine interest scores of the multiple news to be pushed based on a click behavior of the type of the user on the multiple news to be pushed; and

a second redetermining module 970, adapted to calculate and record interest weights of the features of the multiple news to be pushed based on the redetermined interest scores.

In the technical solution of the embodiment, if the user clicks and reads the pushed news, it indicates that the push is accurate; but if the user clicks a button of disinterest for the pushed news, it indicates the user has less interest of the features such as category or theme corresponding to the news. In this case, the interest score of the news is estimated based on the actual behavior of the user and the interest weights of the features of the news are modified in reverse, so that the calculated interest score is more consistent with the actual interest of the user later.

A system for recommending news is further provided according to another embodiment of the disclosure. The search query data includes a query term, the features of the search query data include a category and a theme of the query term, and the behaviors of the type of the user on the search query data includes query behaviors on the query terms of the same category or the same theme.

In the technical solution of the embodiment, a category label and theme label of the query word can be determined in advance according to the category label and theme label of news in a news set corresponding to the query word, a database is set up for storing category labels and theme labels, and the category and theme of the query word can be extracted from the category labels and theme labels in the database. For example, query word abc is searched, if the most theme label of the obtained news is t1, the theme label corresponding to the query word is t1; if the most category label of the obtained news is c1, the category label corresponding to the query word is c1, and then t1 and c1 can be extracted as the features of the category and theme of the query word.

In the technical solution of the embodiment, the difference in the querying behavior of a user on a query word mainly includes difference in the search frequency and difference in the search time. The higher the frequency of searching for a query word, the stronger the interest of the user, then a higher interest weight can be set for the category and the theme of the query word. Meanwhile, the closer the search time points at which a user searches the query word many times are to the current time points, the stronger the interest of the user, then a higher interest weight can be set for the category and the theme of the query word.

A system for recommending news is further provided according to another embodiment of the disclosure. The search query data includes a URL on a query result page, the features of the search query data include a category and a theme of news pointed by the URL, and the behavior of the type of the user on the search query data includes click behaviors on the URLs for the news of the same category or the same theme, or click behaviors on page labels for the news of the same category or the same theme.

In the technical solution of the embodiment, a category label and at least one theme label may be set in advance for each piece of news, and the category and at least one theme of the news may be recorded therein respectively.

In the technical solution of the embodiment, if the user clicks and reads a news pointed by a URL searched, it indicates that the user is interested in the category and theme of the news, and then a higher interest weight can be set; or, if the user clicks a news classifying channel pointed by a URL, and news of the classifying channel has the same category label, it indicates that the user is interested in the category of the news, and then a higher interest weight can be set.

A system for recommending news is further provided according to another embodiment of the disclosure. The search query data includes a URL posted in a social network account, the features of the search query data include a category of a domain name included on the URL, and the behavior of the type of the user on the search query data includes click behaviors on the URLs corresponding to the domain names of the same category.

In the technical solution of the embodiment, category labels can be set for different domain names in advance. For example, a category label for a domain name usually refers to an information category of the web page contained in the webpage under the domain name, such as sports.abc.com, whose webpage may contain various aspects of sport information, and then the category label for this domain name can be identified as “sport”. Category labels for domain names can be pre-stored in the database.

In the technical solution of the embodiment, if the user finds URL posted in a social account by searching and clicks and reads the news pointed by the URL, it indicates that the user is interested in the category and theme of the domain name, and then a higher interest weight can be set.

A system for recommending news is further provided according to another embodiment of the disclosure. An interest score of the i-th news to be pushed is as follows:

$$P = \frac{a}{b + {e}^{- g ( {V}_{i} )}}$$

wherein Vᵢ=x₁×w₁+x₂×w₂+ . . . +x_{N}×w_{N}, w₁ . . . w_{N} are N features of the i-th news to be pushed, x₁ . . . x_{N} are interest weights corresponding to N features, a is a first constant, b is a second constant, and e and g are fixed constants.

In the technical solution of the embodiment, a sorting model may be achieved according to the above-mentioned score formula. The model is used to calculate interest scores with the above formula. The sorting model is actually a logic regression classifier. A feature of the news is an input of the logic regression classifier, and the output of the logic regression classifier is the interest score of the news for a type of user. The higher the score is, the stronger the user is interested in the news to be pushed. Each piece of news can be abstracted as a feature vector, and dimensions of the vector represent a theme, category, even keywords, hot degree and other features of the piece of the news.

Assuming that a model coefficient vector X={x₁,x₂, . . . x_{N}} has been obtained based on the above-mentioned interest weights, a logic regression classifier for calculating interest values of the news may be expressed as:

$$P ( Y = 1 \vert {news}_{i} ) = \frac{1}{1 + {e}^{- g ( V )}}$$

wherein V=XW, X represents a model coefficient vector corresponding to the user of the above-mentioned type, and W represents a feature vector of the news. The meaning at the left side of the above equation is the probability of user clicking when the piece of news news, is recommended to the user, and thus the calculated interest scores at the right side can be used as a basis for pushing news to the type of the user.

In conjunction with the foregoing embodiment, when the user processes the pushed news, W is known, X is unknown, and then X needs to be determined.

According to the click behavior feedback of the user, a set of the news clicked by the user and a set of news which have been pushed to the user but are not clicked by the user can be obtained. For the pushed news news_{c} clicked by the user, the following can be obtained.

$$P ( Y = 1 \vert {news}_{c} ) = \frac{1}{1 + {e}^{- g ( {V}_{c} )}} = 1$$

For the pushed news news_{d} which is not clicked by the user, the following can be obtained.

$$P ( Y = 1 \vert {news}_{d} ) = \frac{1}{1 + {e}^{- g ( {V}_{d} )}} = 0$$

Thus, m formulas with forms as the two expressions described above can be obtained according to records of a user clicking m pieces of the pushed news, the m formulas are solved simultaneously to obtain the sorting model coefficient vector X of the user, that is, interest weights are modified.

After the interest weights are modified, assuming that the model coefficient vector is {x₁, x₂, . . . , x_{N}}, each piece of news in the set of candidate news is extracted to obtain a corresponding feature vector Wᵢ={w₁, w₂, . . . , w_{N}}, which is brought into the following model.

$$P ( Y = 1 \vert {news}_{i} ) = \frac{1}{1 + {e}^{- g ( {V}_{i} )}} ,$$

wherein Vᵢ=x₁×w₁+x₂×w₂+ . . . +x_{N}×w_{N}, and P(Y=1|newsᵢ) is obtained through calculation. This value is an interest score for the piece of news to the user. The order of recommending news to the user can be determined based on the interest scores of the candidate news. Thus, in the technical solution of the embodiment, the interest weights are modified according to the actual click behavior of the user on the pushed news, which benefits to push news again to the user more accurately. Finally, a technical solution is obtained according to this embodiment in conjunction with the above-described embodiments, of which the working flow is shown in FIG. 8.

A lot of details are illustrated in the specification provided here. However, it should be understood that the embodiments of the disclosure can be practiced without the specific details. In some embodiments, a known method, structure and technology are not illustrated in detail, in sort to not obscure understanding for the specification.

Similarly, it should be understood that in sort to simplify the present disclosure and help to understand one or more of the various aspects of the disclosure, in the above description of the exemplary embodiments of the disclosure, the various features of the disclosure are sometimes grouped into a single embodiment, drawing, or description thereof. However, the method disclosed should not be explained as reflecting the following intention: that is, the disclosure sought for protection claims more features than the features clearly recorded in every claim. To be more precise, as is reflected in the following claims, the aspects of the disclosure are less than all the features of a single embodiment disclosed before. Therefore, the claims complying with a specific embodiment are explicitly incorporated into the specific embodiment thereby, wherein every claim itself as an independent embodiment of the disclosure.

Those skilled in the art can understand that adaptive changes can be made to the modules of the devices in the embodiment and the modules can be installed in one or more devices different from the embodiment. The modules or units or elements in the embodiment can be combined into one module or unit or element, and furthermore, they can be separated into more sub-modules or sub-units or sub-elements. Except such features and/or process or that at least some in the unit are mutually exclusive, any combinations can be adopted to combine all the features disclosed by the description (including the attached claims, abstract and figures) and any method or all process of the device or unit disclosed as such. Unless there is otherwise explicit statement, every feature disclosed by the present description (including the attached claims, abstract and figures) can be replaced by substitute feature providing the same, equivalent or similar purpose.

In addition, a person skilled in the art can understand that although some embodiments described here comprise some features instead of other features included in other embodiments, the combination of features of different embodiments means falling into the scope of the disclosure and forming different embodiments. For example, in the following claims, any one of the embodiments sought for protection can be used in various combination modes.

The various components embodiments of the disclosure can be realized by hardware, or realized by software modules running on one or more processors, or realized by combination thereof. A person skilled in the art should understand that microprocessor or digital signal processor (DSP) can be used for realizing some or all functions of some or all components of the systems for recommending contents based on a social network and the systems for recommending news according to the embodiments in the disclosure in practice. The disclosure can also realize one part of or all devices or programs (for example, computer programs and computer program products) used for carrying out the method described here. Such programs for realizing the disclosure can be stored in computer readable medium, or can possess one or more forms of signal. Such signals can be downloaded from the Internet website or be provided at signal carriers, or be provided in any other forms.

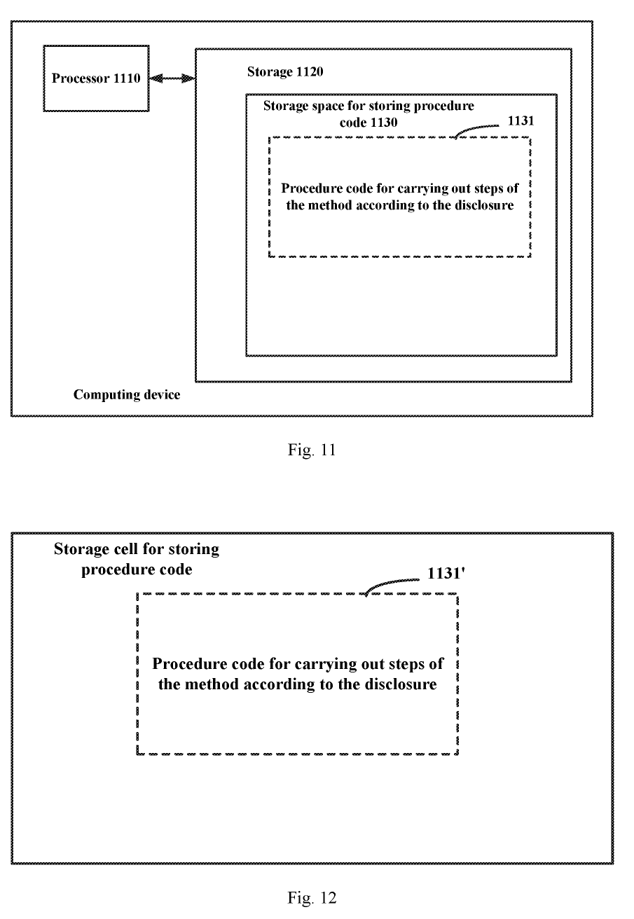

For example, FIG. 11 shows a diagram for a computing device for executing the method for transmitting data between intelligent terminals. The computing device traditionally comprises a processor 1110 and a computer program product in the form of storage 1120 or a computer readable medium. The storage 1120 can be electronic storage such as flash memory, EEPROM (Electrically Erasable Programmable Read-Only Memory), EPROM, hard disk or ROM, and the like. Storage 1120 possesses storage space 1130 for carrying out procedure code 1131 of any steps of aforesaid method. For example, storage space 1130 for procedure code can comprise various procedure codes 1131 used for realizing any steps of aforesaid method. These procedure codes can be read out from one or more computer program products or write in one or more computer program products. The computer program products comprise procedure code carriers such as hard disk, Compact Disc (CD), memory card or floppy disk and the like. These computer program products usually are portable or fixed storage cell as said in FIG. 12. The storage cell may be provided with memory sections, storage spaces, etc., arranged similarly to the storage 1120 in the computing device in FIG. 11. The procedure code can be compressed in, for example, a proper form. Generally, storage cell comprises computer readable code 1131′, i.e. the code can be read by processors such as 1110 and the like. When the codes run on a computer device, the computer device will carry out various steps of the method described above.

The “an embodiment”, “embodiments” or “one or more embodiments” referred here mean being included in at least one embodiment in the disclosure combining specific features, structures or features described in the embodiments. In addition, please note that the phrase “in an embodiment” not necessarily mean a same embodiment.

It should be noticed that the embodiments are intended to illustrate the disclosure and not limit this disclosure, and a person skilled in the art can design substitute embodiments without departing from the scope of the appended claims. In the claims, any reference marks between brackets should not be constructed as limit for the claims. The word “comprise” does not exclude elements or steps that are not listed in the claims. The word “a” or “one” before the elements does not exclude that more such elements exist. The disclosure can be realized by means of hardware comprising several different elements and by means of properly programmed computer. In the unit claims several devices are listed, several of the systems can be embodied by a same hardware item. The use of words first, second and third does not mean any sequence. These words can be explained as name.

In addition, it should be noticed that the language used in the disclosure is chosen for the purpose of readability and teaching, instead of for explaining or limiting the topic of the disclosure. Therefore, it is obvious for a person skilled in the art to make a lot of modification and alteration without departing from the scope and spirit of the appended claims. For the scope of the disclosure, the disclosure is illustrative instead of restrictive. The scope of the disclosure is defined by the appended claims.

1. A method for recommending contents based on a social network, comprising:
extracting features of social network data;
calculating and recording interest weights of the features of the social network data for a type of user according to a behavior of the type of the user on the social network data;
extracting features of a plurality of contents to be pushed;
finding interest weights of the features of the plurality of contents to be pushed from the recorded features and the interest weights, and calculating interest scores of the plurality of contents to be pushed for the type of the user; and
pushing contents to the type of the user according to the interest scores of the plurality of contents to be pushed for the type of the user.

2. The method for recommending contents based on a social network according to claim 1, further comprising:
redetermining the interest scores of the plurality of contents to be pushed based on a click behavior of the type of the user on the plurality of contents to be pushed; and
calculating and recording the interest weights of the features of the plurality of contents to be pushed based on the redetermined interest scores.

3. The method for recommending contents based on a social network according to claim 1, wherein the social network data comprises a social network account, the features of the social network data comprise a category and a theme of the social network account, and the behavior of the type of the user on the social network data comprises a concern behavior on social network accounts of a same category or a same theme.

4. The method for recommending contents based on a social network according to claim 1, wherein the social network data comprises social contents posted in a social network account, the features of the social network data comprise a category and a theme of the social contents, and the behavior of the type of the user on the social network data comprises a forwarding behavior on the social contents of a same category or a same theme.

5. The method for recommending contents based on a social network according to claim 1, wherein the social network data comprises a URL posted in a social network account, the features of the social network data comprise a category and a theme of the pushed content pointed by the URL, and the behavior of the type of the user on the social network data comprises a click behavior on URLs for pushed contents of a same category or a same theme, or a click behavior on page labels for the pushed contents of the same category or the same theme.

6. The method for recommending contents based on a social network according to claim 1, wherein the social network data comprises a URL posted in a social network account, the features of the social network data comprise a category of a domain name included in the URL, and the behavior of the type of the user on the social network data comprises a click behavior on URLs corresponding to domain names of a same category.

7-11. (canceled)

12. A system for recommending contents based on a social network, comprising:
one or more processors; and
a memory;
wherein one or more programs are stored in the memory, and when executed by the one or more processors, the one or more programs cause the one or more processors to:
extract features of social network data;
calculate and record interest weights of the features of the social network data for a type of user according to a behavior of the type of the user on the social network data;
extract features of a plurality of contents to be pushed;
find interest weights of the features of the plurality of contents to be pushed from the recorded features and the interest weights, and calculate interest scores of the plurality of contents to be pushed for the type of the user; and
push contents to the type of the user according to the interest scores of the plurality of contents to be pushed for the type of the user.

13. The system for recommending contents based on a social network according to claim 7, wherein the one or more processors are further caused to:
redetermine interest scores of the plurality of contents to be pushed based on a click behavior of the type of the user on the plurality of contents to be pushed; and
calculate and record the interest weights of the features of the plurality of contents to be pushed based on the redetermined interest scores.

14. The system for recommending contents based on a social network according to claim 7, wherein the social network data comprises a social network account, the features of the social network data comprise a category and a theme of the social network account, and the behavior of the type of the user on the social network data comprises a concern behavior on social network accounts of a same category or a same theme.

15. The system for recommending contents based on a social network according to claim 7, wherein the social network data comprises social contents posted in a social network account, the features of the social network data comprise a category and a theme of the social contents, and the behavior of the type of the user on the social network data comprises a forwarding behavior on the social contents of a same category or a same theme.

16-21. (Canceled)

22. A computer readable medium, which stores computer readable codes, wherein the computer readable codes, when being run on a computing device, cause the computing device to:
extract features of social network data;
calculate and record interest weights of the features of the social network data for a type of user according to a behavior of the type of the user on the social network data;
extract features of a plurality of contents to be pushed;
find interest weights of the features of the plurality of contents to be pushed from the recorded features and the interest weights, and calculate interest scores of the plurality of contents to be pushed for the type of the user; and
push contents to the type of the user according to the interest scores of the plurality of contents to be pushed for the type of the user.

23. The computer readable medium according to claim 11, wherein the computing device is further caused to:
redetermine the interest scores of the plurality of contents to be pushed based on a click behavior of the type of the user on the plurality of contents to be pushed; and
calculate and record the interest weights of the features of the plurality of contents to be pushed based on the redetermined interest scores.

24. The computer readable medium according to claim 11, wherein the social network data comprises a social network account, the features of the social network data comprise a category and a theme of the social network account, and the behavior of the type of the user on the social network data comprises a concern behavior on social network accounts of a same category or a same theme.

25. The computer readable medium according to claim 11, wherein the social network data comprises social contents posted in a social network account, the features of the social network data comprise a category and a theme of the social contents, and the behavior of the type of the user on the social network data comprises a forwarding behavior on the social contents of a same category or a same theme.

26. The computer readable medium according to claim 11, wherein the social network data comprises a URL posted in a social network account, the features of the social network data comprise a category and a theme of the pushed content pointed by the URL, and the behavior of the type of the user on the social network data comprises a click behavior on URLs for pushed contents of a same category or a same theme, or a click behavior on page labels for the pushed contents of the same category or the same theme.

27. The computer readable medium according to claim 11, wherein the social network data comprises a URL posted in a social network account, the features of the social network data comprise a category of a domain name included in the URL, and the behavior of the type of the user on the social network data comprises a click behavior on URLs corresponding to domain names of a same category.
